(19) United States
(12) Patent Application Publication
(10) Pub. No.: US 2013/0199405 A1
(43) Pub. Date: Aug. 8, 2013

(54) CIRCULAR TRACK ACTUATOR SYSTEM

(71) Applicants: Jagan Rangarajan, Fremont, CA (US); Alpay Yilmaz, San Jose, CA (US)

(72) Inventors: Jagan Rangarajan, Fremont, CA (US); Alpay Yilmaz, San Jose, CA (US)

(73) Assignee: APPLIED MATERIALS, INC., Santa Clara, CA (US)

(21) Appl. No.: 13/368,477

(22) Filed: Feb. 8, 2012

(51) Int. Cl. B60L 15/00

(52) U.S. Cl. 104/290

(57) ABSTRACT

Embodiments of the present invention relate to an apparatus and a method for transferring substrate processing equipment. One embodiment of the present invention includes a track assembly having a continuous guide rail formed from a unitary body. The track assembly also includes vertically arranged stator strips for driving motor coils of a plurality of carriages. The motor coils in the carriages may be modular including coil segments of various lengths. The coil segments and the carriages may be driven individually and jointly.

### BACKGROUND

1. Field

Embodiments described herein relate to an apparatus and a method for processing substrates. More particularly, embodiments described herein provide apparatus and methods for transferring and actuating equipments used in processing substrates, for example polishing heads, substrate grippers, and metrology equipments.

2. Description of the Related Art

In the fabrication of integrated circuits and other electronic devices, substrates may be transferred within a processing environment to complete one or more processes. For example, during Chemical Mechanical Polishing (CMP) or Electro-Chemical Mechanical Deposition (ECMP) process, substrates may be retained by polishing heads and travel with the polishing heads among multiple polishing stations in a polishing system to have multiple polishing steps performed thereon. Apparatus and methods for transferring polishing heads with high throughput and precision control. However, in order to achieve satisfactory in precision control, flexibility is often sacrificed. Thus, improved methods and apparatus are needed which increase system flexibility without sacrificing precision control.

### SUMMARY

The present invention generally relate to apparatus and methods for transferring one or more substrate processing equipment along a track.

One embodiment of the present invention relates to a track assembly for substrate processing. The track assembly includes a base plate, a guide rail assembly coupled to the base plate, a linear motor track attached to the base plate along the guide rail assembly, and a plurality of carriages movably coupled to the guide rail assembly. Each of the plurality of carriages includes a motor coil positioned to interact with the linear motor track. The track assembly further comprises a system controller. The system controller is configured to send control signals to the plurality of carriages to move each plurality of carriages independently from each other, and to move two or more neighboring carriages in synchronization so that the two or more neighboring carriages transfer a substrate processing equipment coupled to the two or more neighboring carriages jointly.

Another embodiment of the present invention relates to a substrate processing system. The system includes a track assembly for substrate processing. The track assembly includes a base plate, a guide rail assembly coupled to the base plate, a linear motor track attached to the base plate along the guide rail assembly, and a plurality of carriages movably coupled to the guide rail assembly and the linear motor track. Each of the plurality of carriages includes a motor coil coupled to the linear motor track, and the plurality of carriages are configured to move along the linear motor track independently and jointly. The system further includes one or more substrate processing equipment and two or more processing stations disposed below the track assembly. Each of the one or more substrate processing equipment is coupled to at least one of the plurality of carriages. The one or more substrate processing equipment is selectively positionable among the two or more processing stations.

Yet another embodiment of the present invention relates to a method for processing a substrate. The method includes coupling a substrate processing equipment to two or more carriages of a substrate processing system. The substrate processing system includes a track assembly for substrate processing including a base plate, a guide rail assembly coupled to the base plate, a linear motor track attached to the base plate along the guide rail assembly, and the two or more carriages movably coupled to the guide rail assembly and the linear motor track. Each of two or more carriages includes a motor coil coupled to the linear motor track. The two or more carriages are configured to move along the linear motor track independently and jointly. The method further includes driving the two or more carriages simultaneously to move the substrate processing equipment along the track assembly.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic side view of a substrate processing system with a circular track assembly according to one embodiment of the present invention.

FIG. 2 is a perspective view of a circular track assembly without any equipment coupled thereon according one embodiment of the present invention.

FIG. 3 is a sectional side view of the circular track assembly of FIG. 2.

FIG. 4 is a sectional side view of a track assembly according to another embodiment of the present invention.

FIG. 5 is a bottom view of a circular track assembly with one or more equipments coupled thereon.

To facilitate understanding, identical reference numerals have been used, where possible, to designate identical elements that are common to the figures. It is contemplated that elements disclosed in one embodiment may be beneficially utilized on other embodiments without specific recitation

### DETAILED DESCRIPTION

Embodiments of the present invention relate to an apparatus and a method for transferring substrate processing equipment. Embodiments for the present invention include a track assembly for transferring various substrate processing equipment such as processing devices and/or metrology devices in a substrate processing environment. For example, embodiments of the present invention may be used to transfer processing equipment in the form of polishing heads in a substrate polishing system.

One embodiment of the present invention includes a track assembly having a continuous guide rail formed from a unitary body. The continuous guide rail has improved reliability and increased productivity as compared to segmented guide rail assemblies. The track assembly also includes a continuous encoder integrated to the continuous rail. The continuous encoder eliminates the needs for encoder alignment.

The track assembly according to one embodiment of the present invention also includes vertically arranged stator strips for driving motor coils coupled to a plurality of carriages. The vertically arranged stator strips provide increased torque density creating space for shielding or other equipment.

The motor coils coupled to carriages according to some embodiments of the present invention may be modular including coil segments. The coil segments may be of various lengths for generating various amount of torque. Each of the coil segments may be driven individual to produce different amount of torque. All or a portion of the coil segments may also be driven simultaneously to generate a torque larger than generated by individual segments to drive the equipment attached to the carriage.

According to some embodiments of the present invention, each carriage may be coupled to one piece of equipment and controlled independently to move the equipment along the track system, and one two or more carriages may be coupled to one piece of large equipment at the same time and controlled to move in synchronization to drive the equipment to transfer the large equipment.

Various equipment may be transferred by the track system, such as polishing heads, metrology devices, conditioning tools, alignment tools, and fixtures.

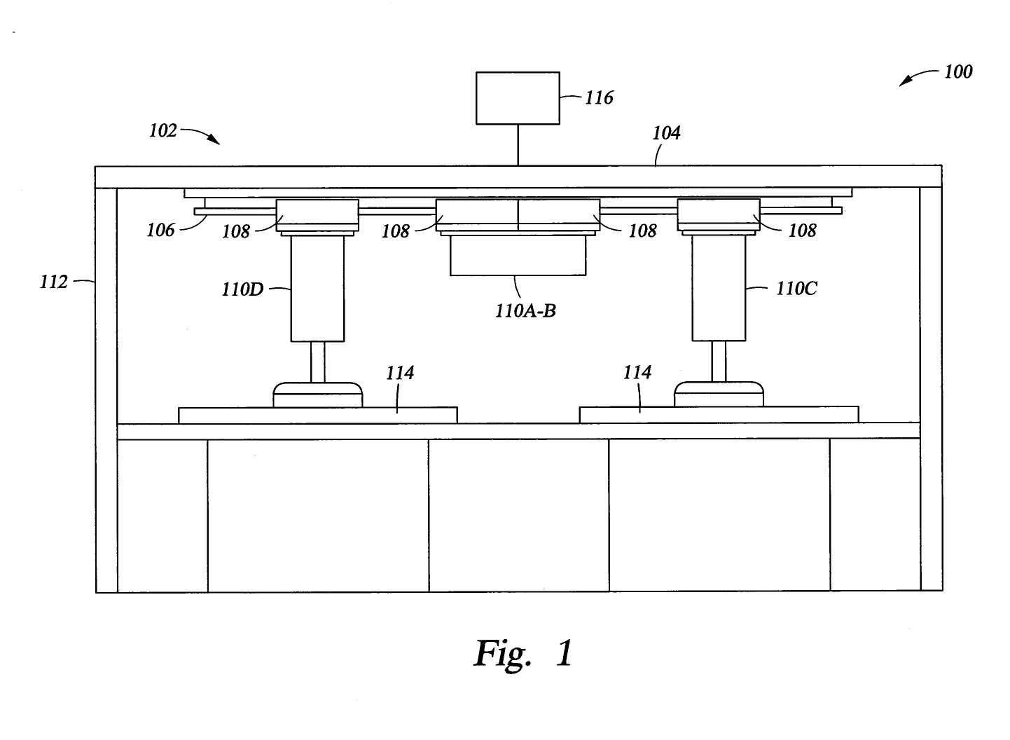

FIG. 1 is a schematic side view of a substrate processing system 100 with a track assembly 102 according to one embodiment of the present invention. The substrate processing system 100 includes a system frame 112 configured to provide support to the track assembly 102 and/or other components of the substrate processing system 100.

The track assembly 102 includes a base plate 104, a guide rail assembly 106 defining a path upon which equipment may travel. The guide rail assembly 106 is attached to a bottom surface 104A of the base plate 104. The track assembly 102 may be linear, non-linear, curved, close looped, circular, non-circular, non-uniform curved path or with a shape of combinations thereof. According to one embodiment of the present invention, the track assembly 102 is a circular track defining a circular path upon which equipment may travel.

The track assembly 102 further includes a linear motor track (not shown in FIG. 1) disposed along the path defined by the guide rail assembly 106. The base plate 104 may be coupled to the system frame 112 in a substantially horizontal orientation so that the bottom surface 104A faces down. A plurality of processing stations 114 may be disposed under the track assembly 102. Each of the processing station 114 may be configured to perform an individual processing function. In one embodiment, the processing function is chemical mechanical or electrochemical mechanical polishing, among others.

The track assembly 102 also includes a plurality of carriages 108 attached to the guide rail assembly 106 and hanging from the guide rail assembly 106. The plurality of carriages 108 may move independently and/or jointly along the guide rail assembly 106. Each of the plurality of carriages 108 may carry and move substrate processing equipment 110A-B, 110C, 110D independently and jointly along the track assembly 102. The plurality of carriages 108 are configured to transfer the substrate processing equipment 110A-B, 110C, 110D along the guide rail assembly 106 and to align with each of the substrate processing equipment 110A-B, 110C, 110D with each of the processing stations 114. As shown in FIG. 1, substrate processing equipment, such as the substrate processing equipment 110C, 110D, may be attached to and carried by a single carriage 108 which is driven individually independent from other carriages 108. Large processing equipment, such as the substrate processing equipment 110A-B, may be coupled to and carried by two or more carriages 108 simultaneously that are controlled in synchronization and driven jointly. The substrate processing equipment 110A-B may include adaptors for coupling to two or more carriages 108 at the same time and to be driven by the combined torque generated from all the two or more carriages 108 attached thereto.

The substrate processing system 100 further include a system controller 116. The system controller 116 may be configured to control the plurality of carriages 108 independently and jointly. The system controller 116 may send control signals to each of the plurality of carriages 108 to control the motion and location of each carriage 108. Additionally, the system controller 116 may send control signals to synchronize multiple or all the carriages 108 and drive the carriages 108 jointly. For example, the system controller 116 may send control signals to the two carriages 108 coupled to the substrate processing equipment 110A-B and drive the two carriages 108 jointly to generate a large torque.

In one embodiment, the substrate processing system 100 may be a substrate polishing system, such as a CMP or ECMP polishing system. The plurality of processing stations 114 may include one or more polishing stations, load cups, and cleaning stations. The substrate processing equipment 110 may include one or more polishing heads configured to transfer and support substrates among the one or more polishing stations. The substrate processing equipment 110 may also include metrology devices, or polishing pad conditioners. Detailed description of exemplary substrate polishing systems may be found in co-owned U.S. patent application Ser. No. 12/420,996, published as US 2009/0258574, entitled “Polishing System Having a Track”, which is incorporated herein by reference.

It is contemplated that the track assembly according to embodiment of the present invention may be used in transfer any suitable processing equipment or devices other than polishing heads, for example metrology devices, conditioning tools, alignment tools, and fixtures

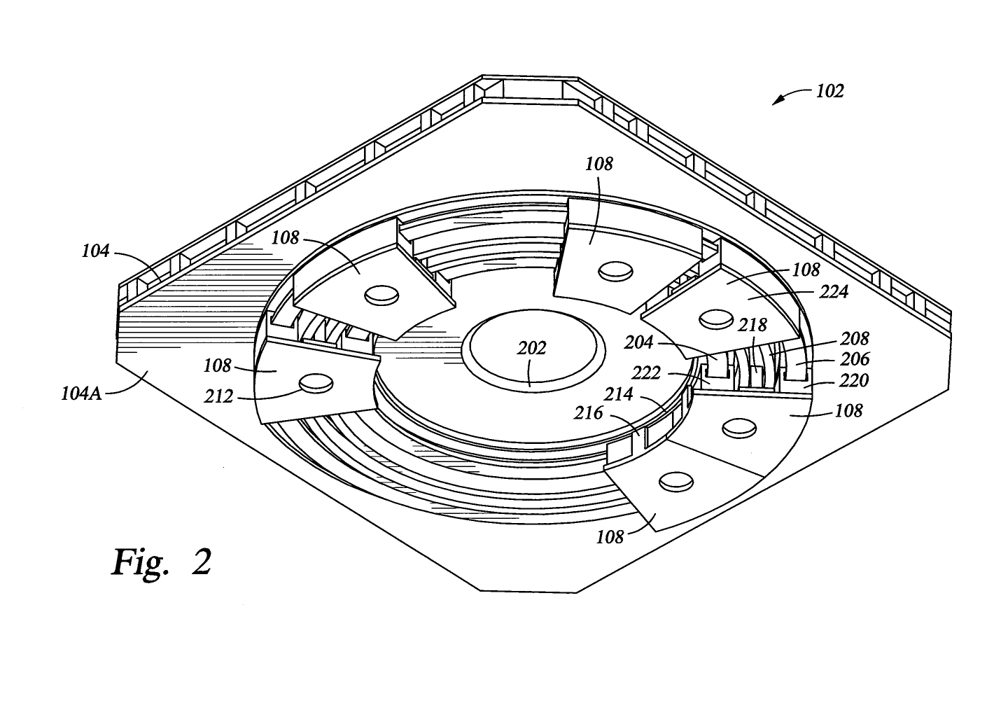

FIG. 2 is a perspective view of the circular track assembly 102 without any substrate processing equipment coupled thereon according one embodiment of the present invention. As shown in FIG. 2, the base plate 104 may be a complex structure formed by multiple components to enhance structure rigidity. A center opening 202 may be through the base plate 104 to allow cables and other wirings for power supplies, control signals, gas or fluid supplies to pass therethrough.

An inner guide rail 204 and an outer guide rail 206 are attached to the bottom surface 104A of the base plate 104. The inner guide rail 204 and the outer guide rail 206 may be both circular and concentrically disposed to define the path on which the equipment is transported. In the embodiment of FIG. 2, the path is circular. A linear motor track 208 including one or more magnetic stator strips is disposed along the inner guide rail 204 and the outer guide rail 206. The linear motor track 208 may be circular and disposed concentrically to the inner guide rail 204 and the outer guide rail 206 along the circular path. As shown in FIG. 2, the linear motor track 208 is disposed between the inner guide rail 204 and the outer guide rail 206. Alternatively, the linear motor track 208 may be disposed radially inside the inner guide rail 204 or radially outside the outer guide rail 206. The plurality of carriages 108 are movably attached to the inner guide rail 204 and the outer guide rail 206, and interfaces with the linear motor track 208 to move along the circular path independently and/or jointly. An encoder scale 214 may be directly attached to the inner guide rail 204. The encoder scale 214 is configured to interact with a sensor 216 attached to each of the plurality of carriages 108 to provide information indicative of the locations of the carriages 108 along the path defined by the inner guide rail 204 and the outer guide rail 206. Alternatively, the encoder scale 214 may be directly attached to the outer guide rail 206.

In one embodiment of the present invention, each of the inner guide rail 204 and the outer guide rail 206 is formed from a unitary body. Thus the inner guide rail 204 is a continuous one piece structure. The outer guide rail 206 may also be a continuous one piece structure. Each of the inner guide rail 204 and the outer guide rail 206 may be machined in one piece, then attached to the base plate 104. The inner guide rail 204 and the outer guide rail 206 may be welded to the base plate 104 in one operation after machining or bolted to the base plate 104 from to the top.

There are several advantages for the continuous unitary inner and outer guide rails 204, 206. The unitary design of guide rails 204, 206 eliminates alignment necessary for segmented rails simplifying manufacturing and installation. The continuous guide rails 204, 206 have no seams, the motion of carriages 108 along the guide rails 204, 206 is very smooth and improves the life of bearings utilized in the carriages 108 and eliminates potential particle generation as the bearings cross the rail seams. The unitary design of the guide rails 204, 206 also reduces number of parts in the track assembly 102 thus improving reliability. The unitary design also eliminates exposed fasteners or other features that could collect debris/particles during operation, thus increasing lifetime of the track assembly 102 and improving processing results because of reduced particle contamination.

The unitary design of the guide rails 204, 206 also enables the encoder scale 214 attached to the inner guide rail 204 or outer guide rail 206 to be continuous too. In one embodiment, the encoder scale 214 is a continuous ring encoder. A continuous encoder scale 214 has no dead zones as opposed to segmented encoder scales. The plurality of carriages 108 can share the same continuous encoder scale 214, thus, reducing costs and improving reliability and accuracy. Additionally, because the encoder scale 214 is attached to the guide rail 204, 206 directly, no additional alignment is required.

Each carriage 108 may include a carriage body 224 having one or more bearing blocks 220, 222 and a motor coil 218 attached to the carriage body 224. A mounting interface 212 may be formed in the carriage body 224 for receiving a load, such as the substrate processing equipment 110A-B, 110C, 110D of FIG. 1. The mounting interface 212 may be studs, a through hole, a boss with cross hole for lynch pin or other structure suitable for securing equipment to the carriage 108.

The one or more sliding blocks 220, 222 is configured to be movably attached the inner guide rail 204 and outer guide rail 206 so that the carriage 108 can freely move along the inner guide rail 204 and the outer guide rail 206. Detailed description of exemplary sliding blocks may be found in co-owned U.S. patent application Ser. No. 12/420,996, published as US 2009/0258574, entitled “Polishing System Having a Track”. The blocks 220, 222 may include solid bearings, ball bearings, or roller bearings and the like.

The motor coil 218 in each carriage 108 may be driven independently to move each carriage 108 independently relative the other carriages 108 along the linear motor track 208. The motor coil 218 interacts with the magnetic stator strips of the linear motor track 208 to move the carriage 108 along the path defined by the inner guide rail 204 and outer guide rail 206 and to position (or stop) the carriage 108 in desired locations along the inner guide rail 204 and outer guide rail 206. The motor coil 218 may be modular for generating different torques for transferring different loads. The motor coil 218 may include multiple coil segments of various lengths. In one embodiment, the motor coil 218 may include multiple coil segments of various arc lengths. Combinations of different coil segments may be activated to generate different torques.

According to one embodiment of the present embodiment, the motor coils 218 of at least two neighboring carriages 108 may be driven jointly to generate large torque for carrying a heavy load. For example, a single heavy load, such as a large substrate processing equipment, may be coupled to two or more carriages 108 at the same time. The motor coils 218 in the two or more carriages 108 may be driven jointly, thus synchronized, to generate a large torque to efficiently move the single load. The capability of carrying a load jointly with two or more individually controllable carriages 108 increases the capacity of the track assembly 102 without sacrificing flexibility thereby.

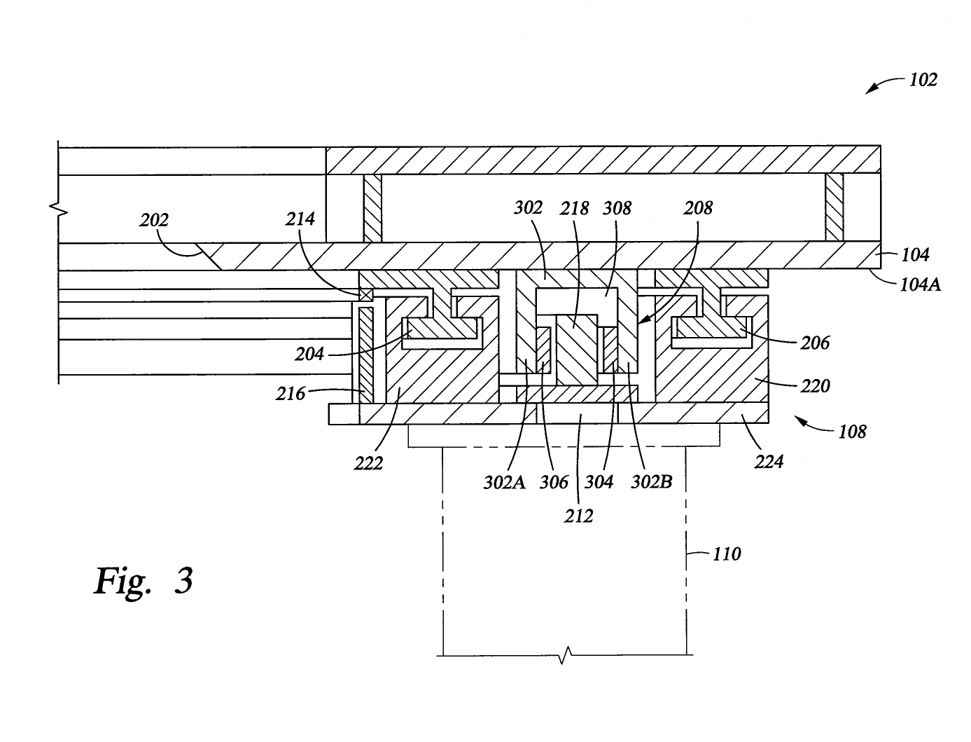

FIG. 3 is a sectional side view of the circular track assembly 102 of FIG. 2 showing details of the linear motor track 208 according to one embodiment of the present invention. The linear motor track 208 includes a frame 302 attached to the base plate 104 and two magnetic stator strips 304 and 306 attached to the frame 302. The stator strips 304, 306 may include multiple segments. The frame 302 may be a ring having two walls 302A, 302B extending downwardly. The sectional view of the frame 302 is similar to an upside down “U” shape. Alternatively, the frame 302 may include two separate portion attached to the base plate 104. For example, the frame 302 may include an inner ring and an outer ring attached to the base plate 104 such that the inner ring, the outer ring and the base plate 104 between the inner ring and outer ring form an upside down “U” shape. The frame 302 defines a recess 308 opening downward for receiving the motor coils 218 of the plurality of carriages 108. The magnetic stator strips 304, 306 are attached to walls 302A, 302B within the recess 308. The magnetic stator strips 304, 306 are substantially parallel to each other in the sectional view of FIG. 3. For the circular track assembly 102, the magnetic stator strips 304, 306 are concentric to one another and also concentric with the guide rails 204, 206. The magnetic stator strips 304, 306 are vertically oriented and face each other. The motor coils 218 are also vertically oriented and disposed between the two magnetic stator strips 304 and 306. In an alternative embodiment, segments of motor coil may be coupled to the linear motor track 208 while magnetic stator strips are coupled to the carriages 108 to interact with the motor coil segments on the linear motor track 208.

The vertically arranged stator strips allows improved magnetic interaction between the stator strips and the motor coils, thus providing increased torque density compared to horizontally arranged stator strips. Therefore, vertically arranged stator strips saves space and provide room for shielding or other equipment. Additionally, the downward opening recess 308 also enables easy installation for the carriages 108.

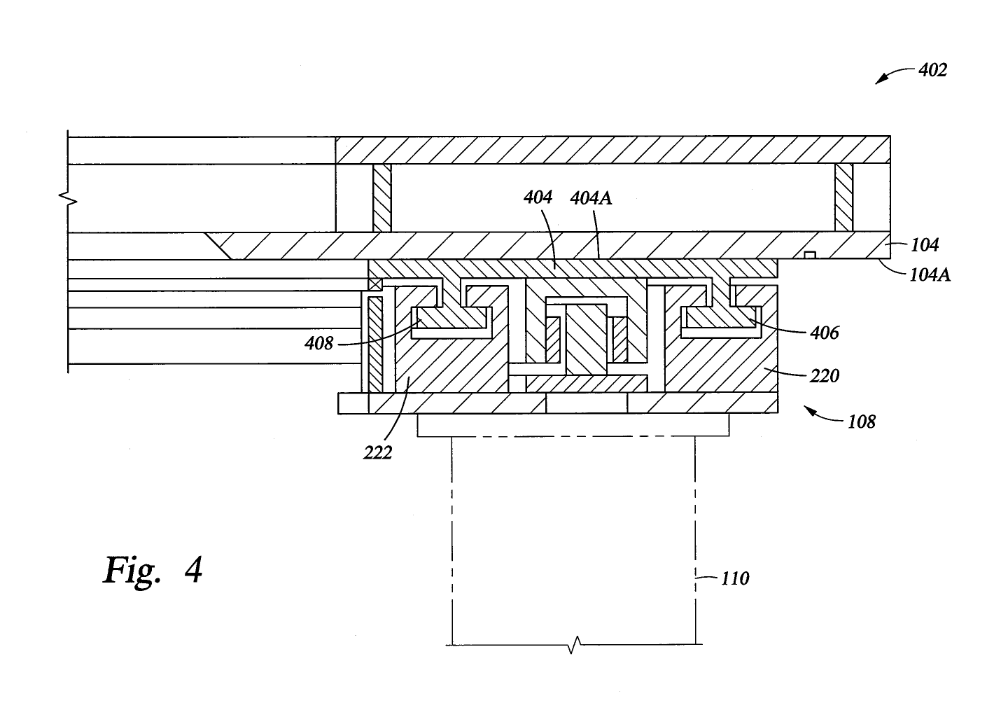

FIG. 4 is a sectional side view of a track assembly 402 according to another embodiment of the present invention. The track assembly 402 is similar to the track assembly 102 described above, except that the track assembly 402 includes an integrated rail plate 404. The rail plate 404 may be a ring shaped plate for a circular track. A top side 404A of the rail plate 404 is attached to the base plate 104. A bottom side 404B of the rail plate 404 has two guide rails 406, 408 extending therefrom. The guide rails 406, 408 may be concentric rails for a circular track. The guide rails 406, 408 are continuous guide rails as described above. The guide rails 406, 408 and the rail plate 404 may be fabricated to form a single one piece unitary body. By incorporating the rail plate 404, the guide rails 406, 408 may have shorter lengths compared to the guide rails 204, 206. The shorter lengths provide increased stiffness to the guide rails 406, 408, therefore, reduce lateral deflection caused by external loads. The integrated rail plate 404 and the guide rails 406, 408 are smaller in size than the combination of guide rails and the base plate, thus, may be manufactured together, further reducing the needs for alignment and fastening parts.

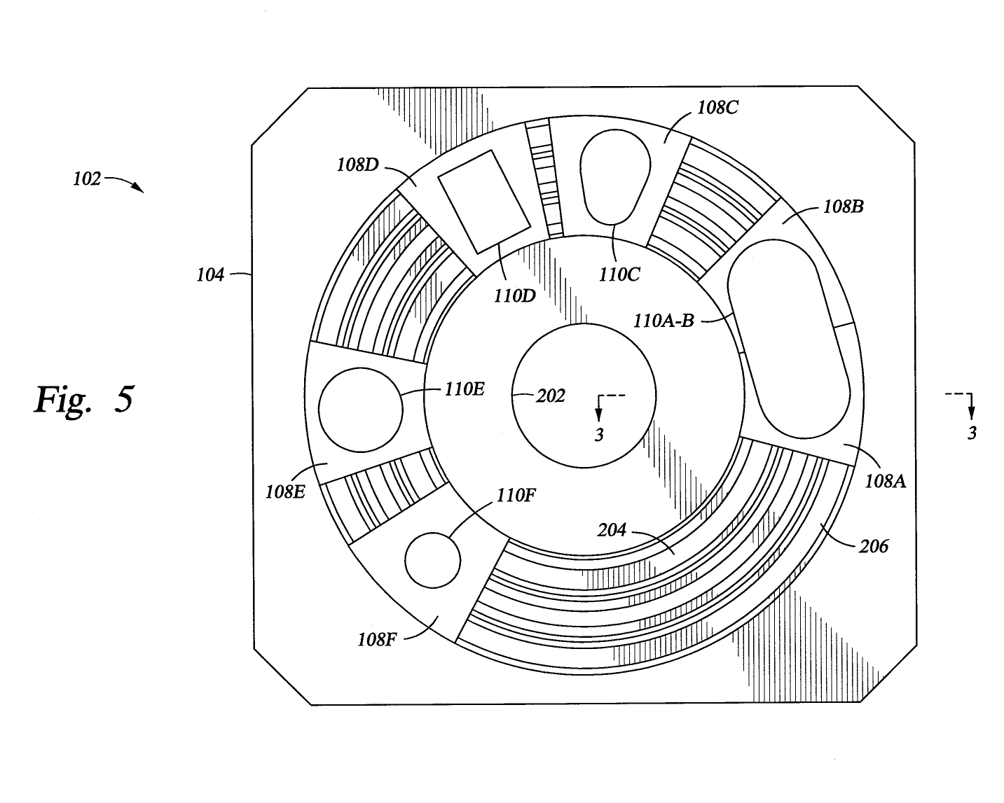

FIG. 5 is a bottom view of the circular track assembly 102 with one or more equipments 110A-B, 110C, 110D, 110E and 110F coupled thereon. The plurality of carriages 108 may be used individually and jointly to carry various equipments. The equipments 110A-B, 110C, 110D, 110E and 110F may be the same or different from one another. Each equipment 110A-B, 110C, 110D, 110E and 110F may be coupled to different number of carriages 108 to meet the torque requirement for the particular equipment. In one embodiment, the equipment 110A-B may include structures for coupling to multiple neighboring carriages 108.

Embodiments of the present invention also include a method for processing a substrate. The method includes coupling a substrate processing equipment to two or more carriages of a substrate processing system. The substrate processing system includes a track assembly for substrate processing including a base plate, a guide rail assembly coupled to the base plate, a linear motor track attached to the base plate along the guide rail assembly, and the two or more carriages movably coupled to the guide rail assembly and the linear motor track. Each of two or more carriages includes a motor coil coupled to the linear motor track. The two or more carriages are configured to move along the linear motor track independently and jointly. The method further includes driving the two or more carriages simultaneously to move the substrate processing equipment along the track assembly.

In one embodiment of the method for processing a substrate, the substrate processing equipment is a polishing head and/or a metrology device

While the foregoing is directed to embodiments of the present invention, other and further embodiments of the invention may be devised without departing from the basic scope thereof, and the scope thereof is determined by the claims that follow.

1. An apparatus for substrate processing, comprising:
a base plate;
a guide rail assembly coupled to the base plate;
a linear motor track attached to the base plate along the guide rail assembly;
a plurality of carriages movably coupled to the guide rail assembly, wherein each of the plurality of carriages comprises a motor coil positioned to interact with the linear motor track; and
a system controller, wherein the system controller is configured to send control signals to the plurality of carriages to move each plurality of carriages independently from each other, and to move two or more neighboring carriages in synchronization so that the two or more neighboring carriages transfer a substrate processing equipment coupled to the two or more neighboring carriages jointly.

2. The apparatus of claim 1, wherein the guide rail assembly and the linear motor track form a circular path.

3. The apparatus of claim 2, wherein the guide rail assembly comprises a first rail formed from a unitary body.

4. The apparatus of claim 3, wherein the guide rail assembly comprises a second rails formed from a unitary body, and the first and second rails are concentric circles, and the linear motor track is concentrically positioned between the first and second rails.

5. The apparatus of claim 2, wherein the linear motor track comprises:
a first stator strip comprising a plurality of first permanent magnetic segments; and
a second stator strip comprising a plurality of second permanent magnetic segments facing the plurality of first permanent magnetic segments, wherein the plurality of first permanent magnets segments and the plurality of second permanent magnetic segments are vertically oriented and form a gap having an opening facing down for receiving the motor coils of the plurality of carriages between the plurality of first and second magnetic segments.

6. The apparatus of claim 3, further comprising an encoder scale attached to the first rail.

7. The apparatus of claim 6, wherein the encoder scale is a continuous ring encoder.

8. The apparatus of claim 2, wherein the guide rail assembly comprises:
a ring shaped rail plate having a first side attached to the base plate;
a first continuous rail extending from a second side of the ring shaped rail; and
a second continuous rail extending from the second side of the ring shape, wherein the first and second continuous rails are concentric.

9. The apparatus of claim 1, wherein the motor coils in the plurality of carriages comprises multiple segmented coils of various lengths, and different combinations of the multiple segmented coils are used to drive the two or more carriages depending on torque requirement for transferring the substrate processing equipments attached to the plurality of carriages.

10. The apparatus of claim 9, wherein controller is configured to drive any number of the plurality of carriages simultaneously to drive one substrate processing equipment together.

11. The apparatus of claim 1, further comprising:
one or more substrate processing equipment, wherein each of the one or more substrate processing equipment is coupled to at least one of the plurality of carriages; and
two or more processing stations disposed below the one or more substrate processing equipment, wherein the at least one of the plurality of carriages move the one or more substrate processing equipment among the two or more processing stations.

12. The apparatus of the claim 11, wherein the one or more substrate processing equipment comprises a first equipment coupled to at least two of the plurality of carriages, and the at least two of the plurality of carriages drive the first equipment jointly.

13. The apparatus of claim 11, wherein the guide rail assembly and the linear motor track form a circular path, and the guide rail assembly comprises a first rail formed from a unitary body.

14. The apparatus of claim 13, wherein the guide rail assembly comprises a second rails formed from a unitary body, and the first and second rails are concentric circles, and the linear motor track is concentrically positioned between the first and second rails.

15. The apparatus of claim 11, wherein the linear motor track comprises:
a first stator strip comprising a plurality of first permanent magnetic segments; and
a second stator strip comprising a plurality of second permanent magnetic segments facing the plurality of first permanent magnetic segments, wherein the plurality of first permanent magnets segments and the plurality of second permanent magnetic segments are vertically oriented and form a gap having an opening facing down for receiving the motor coils of the plurality of carriages between the plurality of first and second magnetic segments.

16. The apparatus of claim 13, further comprising an encoder scale attached to the first rail, and the encoder scale is a continuous ring encoder.

17. The apparatus of claim 11, wherein the two or more processing stations comprise two or more polishing stations, and the one or more substrate processing equipment comprise one or more polishing heads.

18. The apparatus of claim 11, wherein the one or more substrate processing equipment comprise a metrology device.

19. The apparatus of claim 1, further comprising one or more substrate processing equipment, wherein each of the one or more substrate processing equipment is coupled to at least one of the plurality of carriages.

20. The apparatus of claim 1, further comprising two or more processing stations disposed below the plurality of carriages, wherein each of the plurality of carriages passes over each of the processing stations when moving along the linear motor track.
